(19) United States
(12) Patent Application Publication
(10) Pub. No.: US 2021/0357399 A1
(43) Pub. Date: Nov. 18, 2021

(54) METHOD OF PROCESSING DATABASE AND INFORMATION PROCESSING APPARATUS

(71) Applicant: FUJITSU LIMITED, Kawasaki-shi (JP)

(72) Inventors: Thielooumar Katou, Kawasaki (JP); Yusuke Komaba, Inagi (JP)

(73) Assignee: FUJITSU LIMITED, Kawasaki-shi (JP)

(21) Appl. No.: 17/179,025

(22) Filed: Feb. 18, 2021

(30) Foreign Application Priority Data
May 12, 2020 (JP) 2020-084156

(51) Int. Cl. G06F 16/2455; G06F 16/28; G06F 16/248; G06F 16/25

(52) U.S. Cl. CPC G06F 16/2456; G06F 16/24552; G06F 16/258; G06F 16/284; G06F 16/248; G06F 16/24561

(57) ABSTRACT

A method of processing database includes receiving, by a computer, an instruction from an application, the instruction being related to a plurality of database management systems including a database management system that performs an operation over a plurality of pieces of table data, specifying a database management system among the plurality of database management systems; acquiring intermediate table data used to execute the instruction from a database management system other than the specified database management system, storing the acquired intermediate table data in a database managed by the specified database management system, requesting execution of the instruction to the specified database management system, acquiring response table data from the specified database management system, and returning the acquired response table data to the application as a response to the instruction.

### CROSS-REFERENCE TO RELATED APPLICATION

This application is based upon and claims the benefit of the prior Japanese Patent Application No. 2020-084156 filed on May 12, 2020, the entire contents of which are incorporated herein by reference.

### FIELD

The embodiment discussed herein is related to a method of processing database and an information processing apparatus.

### BACKGROUND

In recent years, with the spread of cloud environments, there is an increasing need for user applications to connect to multiple types of databases. For example, a user application may access an SQL database and a NoSQL database. For this reason, there is a technology for providing a general-purpose DB (database) connector between a user application and a plurality of types of DBMSs (database management systems). In this technology, the general-purpose DB connector receives a request from the user application, requests processing from a plurality of types of DBMSs based on the received request, and receives a processing result for the requested processing from the plurality of types of DBMSs. Then, the general-purpose DB connector returns a response to the user application based on the received processing result.

As a related art, there is a technology for efficiently accessing data stored in a graph-type database by using an interface of a relational database. In this technology, a calculator acquires a reference frequency for each node type in the graph-type database, extracts the types of nodes whose reference frequency is equal to or greater than a threshold, converts the nodes of the extracted types into a table structure, and then holds the converted nodes as an intermediate table. Then, the calculator receives the query of the relational database and refers to the intermediate table that has been held.

In addition, there is a technology of the related art for providing a general-purpose DB connector for connecting a plurality of types of DBs via a REST (representational state transfer) API (application programming interface). The general-purpose DB connector is provided in an intermediate layer that parses and converts the query between the user application and the DB. The general-purpose DB connector provides a unified API (REST API) that may access various DBs in the same way. The general-purpose DB connector provides a data model that abstracts the data structures of various DBs.

Related technologies are disclosed in, for example, International Publication Pamphlet No. WO 2014/109009 and Rami Sellami; Sami Bhiri; Bruno Defude, “ODBAPI:A Unified REST API for Relational and NoSQL Data Stores,” 2014 IEEE International Congress on Big Data.

### SUMMARY

According to an aspect of the embodiment, a method of processing database includes receiving, by a computer, an instruction from an application, the instruction being related to a plurality of database management systems including a database management system that performs an operation over a plurality of pieces of table data; specifying a database management system among the plurality of database management systems; acquiring intermediate table data used to execute the instruction from a database management system other than the specified database management system; storing the acquired intermediate table data in a database managed by the specified database management system; requesting execution of the instruction to the specified database management system; acquiring response table data from the specified database management system; and returning the acquired response table data to the application as a response to the instruction.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a JOIN operation;

FIG. 2A is a diagram illustrating an example of a JOIN query;

FIG. 2B is a diagram illustrating an example of a JOIN process using two PostgresDBs;

FIG. 2C is a diagram illustrating an example of the JOIN query;

FIG. 2D is a diagram illustrating an example of a JOIN process using MongoDB and PostgresDB;

FIG. 3 is a diagram illustrating a configuration of an integrated DBMS according to an embodiment;

FIG. 4 is a diagram illustrating a functional configuration of a general-purpose DB connector;

FIG. 5 is a diagram for explaining the reason for requesting a back-end DBMS group to lock the DB;

FIG. 6 is a flowchart illustrating a flow of processing by a general-purpose DB connector;

FIG. 7 is a diagram illustrating a flow of query optimization processing by a query optimization processing unit;

FIG. 8 is a diagram illustrating a lock sequence that prevents the DB from being updated while cache is in use;

FIG. 9 is a diagram illustrating a lock sequence that disables cache data while the DB is being updated;

FIG. 10 is a flowchart illustrating a flow of processing in which the general-purpose DB connector updates the cache when the DB is updated;

FIG. 11 is a flowchart illustrating a flow of processing in which a user application reads cache data after updating the cache;

FIG. 12 is a diagram illustrating a hardware configuration of a computer that executes a database processing program according to the embodiment; and

FIG. 13 is a diagram for explaining the JOIN process by the general-purpose DB connector.

### DESCRIPTION OF EMBODIMENT

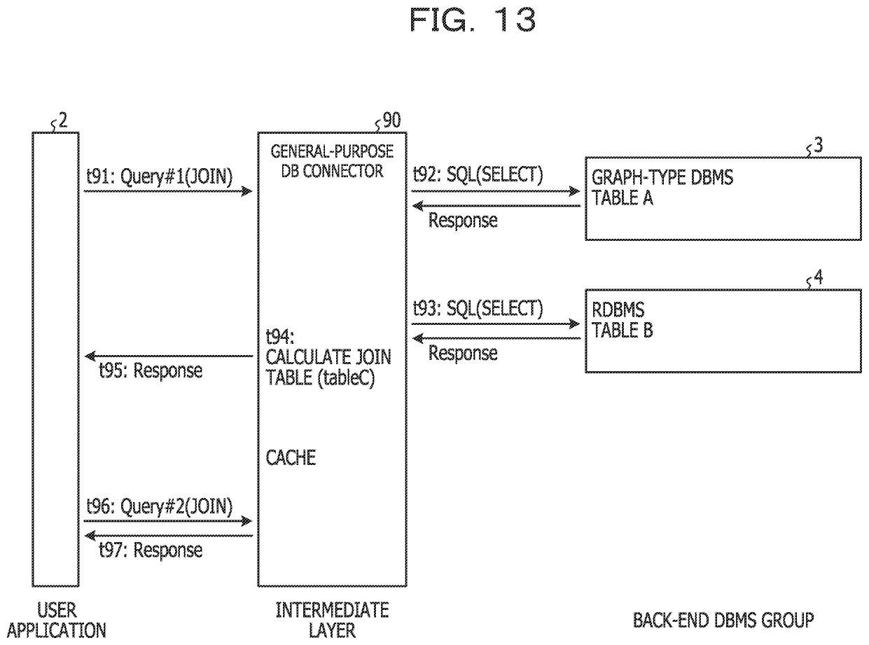

The general-purpose DB connector has a problem that it is costly to implement. FIG. 13 is a diagram for explaining a JOIN process by the general-purpose DB connector. As illustrated in FIG. 13, the general-purpose DB connector 90 is provided in an intermediate layer between the user application and a back-end DBMS group. The back-end DBMS group includes a graph-type DBMS3 and an RDB (relational DB: relational database) MS4.

Upon receiving a query (Query) related to a JOIN operation from the user application 2 (t91), the general-purpose DB connector 90 issues a SELECT statement to the graph-type DBMS3 (t92), and receives the graph-type DB data (table A) as a response. Then, the general-purpose DB connector 90 converts the graph-type DB data into table structure data and stores the converted data in a memory. Further, the general-purpose DB connector 90 issues a SELECT statement to RDBMS 4 (relational database management system 4) (t93), receives the table structure data (table B) as a response, and stores the received data in the memory.

Then, the general-purpose DB connector 90 calculates the JOIN table (table C) using the two pieces of table structure data stored in the memory (t94), and responds to the user application 2 with the data of the JOIN table (t95). The general-purpose DB connector 90 calculates the JOIN table using dedicated software or hardware. Further, the general-purpose DB connector 90 caches the JOIN table. Subsequently, upon receiving the same query from the user application 2 (t96), the general-purpose DB connector 90 searches for the cache and responds to the user application 2 (t97).

In this way, the general-purpose DB connector 90 calculates the JOIN table using dedicated software or hardware. Therefore, in the general-purpose DB connector 90, it is necessary to develop dedicated software or hardware, which requires development cost. Similarly, for the general-purpose DB connector 90, it is necessary to develop dedicated software or hardware for other complicated operations such as a MERGE operation, which requires development cost. Further, the complicated operation is an operation that is performed over a plurality of tables.

Hereinafter, an embodiment of a method of processing database and an information processing apparatus disclosed in the present invention will be described in detail with reference to the accompanying drawings. Further, the embodiment does not limit the disclosed technology.

### Embodiment

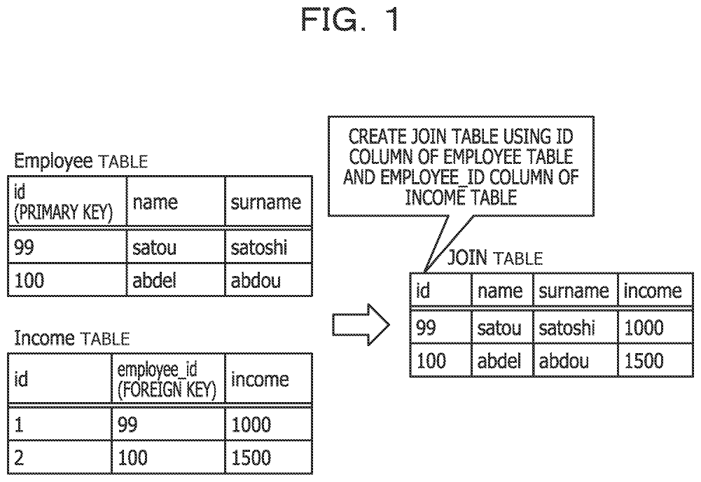

First, an example of a JOIN operation will be described as an example of a complicated operation in an RDB (relational database). RDBMS 4 implements a table JOIN operation by using column names that represent the relationships between tables. FIG. 1 is a diagram illustrating an example of the JOIN operation. As illustrated in FIG. 1, RDBMS 4 uses the identification (id) of the Employee table as the primary key and the employee_id of the Income table as the foreign key, and joins the records (rows) of the Income table having the same primary key and foreign key to the Employee table to create a JOIN table.

For example, the record (99, Satou, Satoshi, 1000) in the JOIN table is obtained by joining the record (99, Satou, Satoshi) whose id is “99” in the Employee table to the record (1, 99, 1000) whose employee_id is “99” in the Income table. Columns other than the primary key of the JOIN table are designated in the JOIN operation. Such a JOIN operation that is performed over a plurality of tables is not found in a key-value type DBMS such as, for example, Redis.

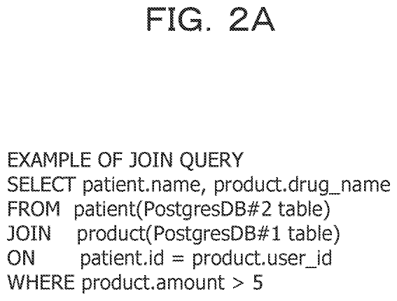

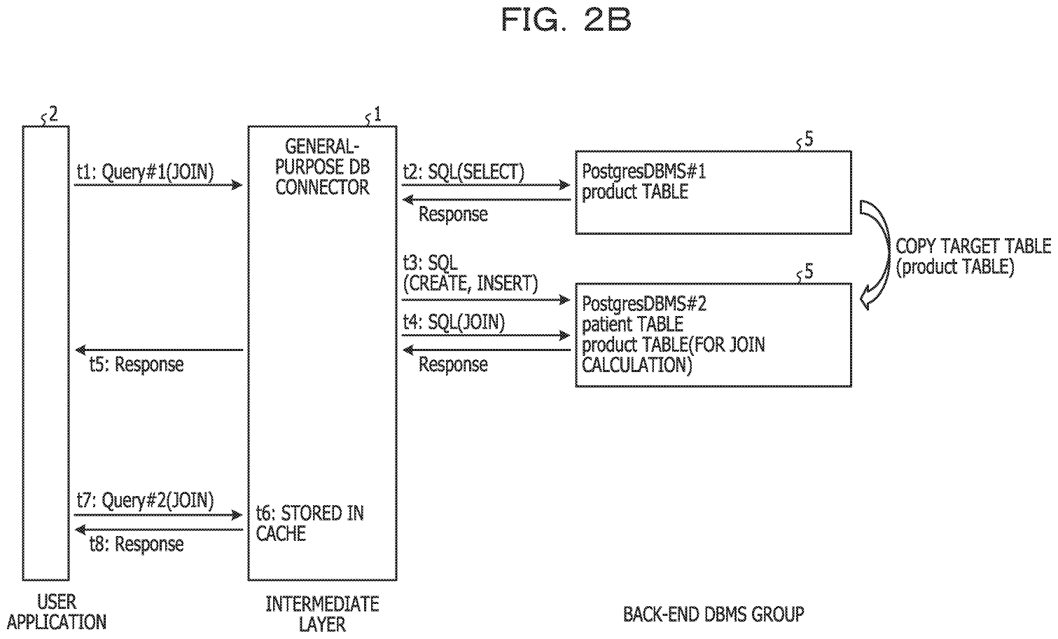

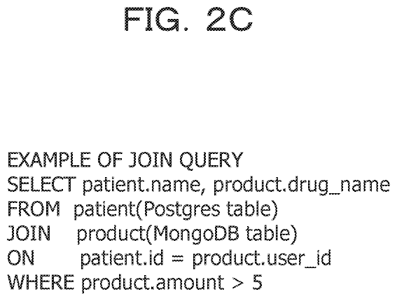

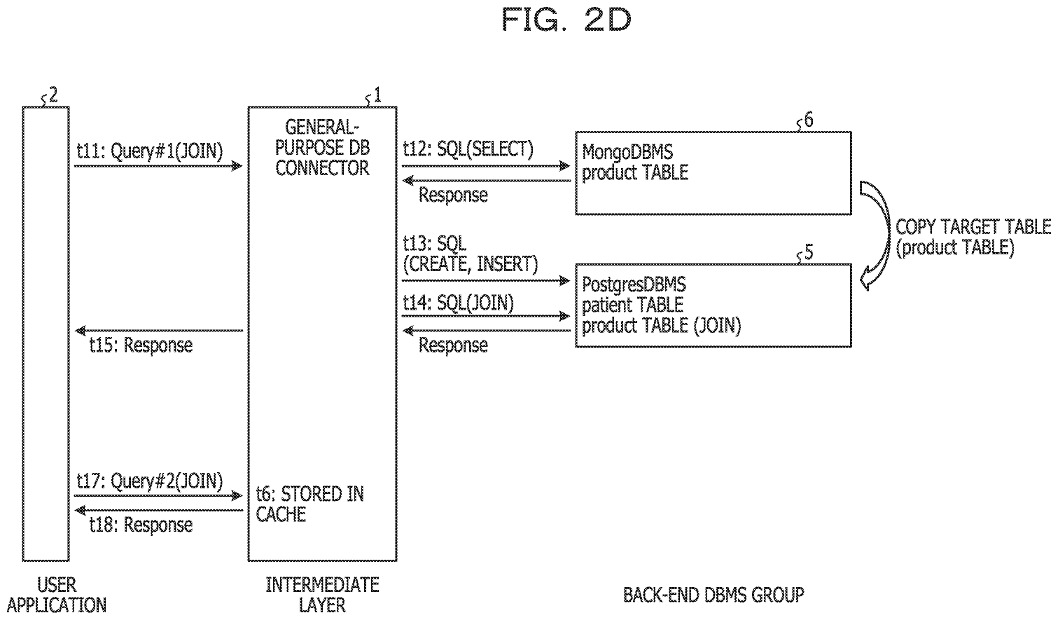

Next, the JOIN process by the general-purpose DB connector according to an embodiment will be described with reference to FIGS. 2A to 2D. Further, the general-purpose DB connector according to the embodiment operates as an information processing apparatus for processing database, which is arranged in an intermediate layer between a user application and a back-end DBMS group. FIGS. 2A and 2C illustrate an example of a JOIN query, FIG. 2B illustrates a case where the JOIN process is performed using two PostgresDBs, and FIG. 2D illustrates a case where the JOIN process is performed using MongoDB and PostgresDB. PostgresDB is an RDB and MongoDB is a NoSQL type DB.

As illustrated in FIG. 2A, the JOIN query queries the patient.name and the product.drug_name in which the patient.id of the patient table of PostgresDB #2 and the product.user_id of the product table of PostgresDB #1 are equal and the product.amount is greater than 5.

As illustrated in FIG. 2B, the general-purpose DB connector 1 according to the embodiment receives the query illustrated in FIG. 2A from the user application 2 (t1). Then, the general-purpose DB connector 1 according to the embodiment issues a SELECT statement to PostgresDBMS 5 represented by PostgresDBMS #1 (t2), and receives a product table as a response. Then, the general-purpose DB connector 1 issues a CREATE statement to be inserted into PostgresDBMS 5 represented by PostgresDBMS #2, and creates a product table in PostgresDBMS #2 (t3).

That is, the product table is copied from PostgresDB #1 to PostgresDB #2. Further, since the size of the product table is smaller than the size of the patient table as a result of comparing the sizes of the product table and the patient table, the general-purpose DB connector 1 copies the product table from PostgresDB #1 to PostgresDB #2. The product table of PostgresDB #2 is used for the JOIN calculation.

Then, the general-purpose DB connector 1 issues a JOIN query to PostgresDBMS #2 (t4). Then, PostgresDBMS #2 calculates the JOIN table using the patient table and the product table to respond to the general-purpose DB connector 1 with the data in the JOIN table. Then, the general-purpose DB connector 1 responds to the user application 2 with the data in the JOIN table (t5).

Subsequently, the general-purpose DB connector 1 caches the JOIN table (t6). Then, upon receiving the same query from the user application 2 (t7), the general-purpose DB connector 1 searches for the cache and responds to the user application 2 (t8).

In this way, the general-purpose DB connector 1 copies the smaller one of the two tables which are the targets of the JOIN process to another PostgresDB, and performs a JOIN operation using the JOIN function of PostgresDBMS 5. Therefore, the general-purpose DB connector 1 may eliminate the need for dedicated software or hardware for performing the JOIN operation.

Further, as illustrated in FIG. 2C, the JOIN query queries the patient.name and the product.drug_name in which the patient.id of the patient table of PostgresDB and the product.user_id of the product table of MongoDB are equal and the product.amount is greater than 5.

As illustrated in FIG. 2D, upon receiving the query illustrated in FIG. 2C from the user application 2 (t11), the general-purpose DB connector 1 issues a SELECT statement to MongoDBMS 6 (t12), and receives the product table as a response. Then, the general-purpose DB connector 1 issues a CREATE statement to be inserted into PostgresDBMS 5 and creates a product table in PostgresDB (t13).

That is, the product table is copied from MongoDB to PostgresDB. Since MongoDBMS 6 does not support the JOIN operation, the general-purpose DB connector 1 copies the product table from MongoDB to PostgresDB. The product table of PostgresDB is used for the JOIN calculation.

Then, the general-purpose DB connector 1 issues a JOIN query to PostgresDBMS 5 (t14). Then, PostgresDBMS 5 calculates the JOIN table using the patient table and the product table to respond to the general-purpose DB connector 1 with the data of the JOIN table. Then, the general-purpose DB connector 1 responds to the user application 2 with the data in the JOIN table (t15).

Subsequently, the general-purpose DB connector 1 caches the JOIN table (t16). Then, when receiving the same query from the user application 2 (t17), the general-purpose DB connector 1 searches for the cache and responds to the user application 2 (t18).

In this way, the general-purpose DB connector 1 copies the product table of MongoDB to the PostgresDBMS 5 that supports the JOIN operation among the DBMSs that store the two tables which are the targets of the JOIN process. Then, the general-purpose DB connector 1 performs the JOIN operation using the JOIN function of PostgresDBMS 5. Therefore, the general-purpose DB connector 1 may eliminate the need for dedicated software or hardware for performing the JOIN operation.

Further, although the JOIN process has been described in FIGS. 2A to 2D, the general-purpose DB connector 1 also performs the same process for a MERGE query.

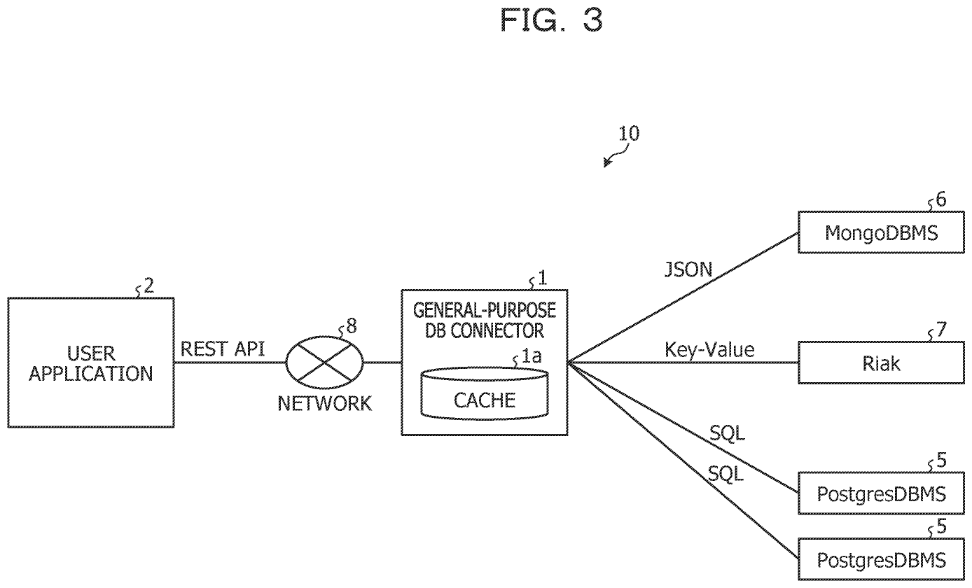

Next, the configuration of the integrated DBMS according to the embodiment will be described. FIG. 3 is a diagram illustrating a configuration of the integrated DBMS according to the embodiment. As illustrated in FIG. 3, the integrated DBMS 10 according to the embodiment includes the general-purpose DB connector 1, MongoDBMS 6, Riak 7, and two PostgresDBMSs 5.

The general-purpose DB connector 1 receives a request from the user application 2 via a network 8. The user application 2 transmits a request to the general-purpose DB connector 1 using the REST API. Based on the received request, the general-purpose DB connector 1 requests processing to at least one of MongoDBMS 6, Riak 7, and two PostgresDBMSs 5, and receives the processing result for the requested processing from the request destination. Then, the general-purpose DB connector 1 performs necessary processing based on the received processing result and request, and returns a response to the user application 2.

The general-purpose DB connector 1 includes a cache 1a. The cache 1a is a part of the information stored by the back-end DB group. Here, the back-end DB group is MongoDB, RiakDB, and two PostgresDBs. The general-purpose DB connector 1 stores the cache 1a using Redis. Redis is an in-memory key-value store DBMS.

MongoDBMS 6 is a DBMS that stores data in a JSON (JavaScript Object Notation) format. MongoDBMS 6 does not support complicated operations such as JOIN and MERGE. In MongoDBMS 6, a request from the general-purpose DB connector 1 to MongoDBMS 6 is made in the JSON format.

Riak 7 is a DBMS that stores data in a key-value format. Riak 7 does not support complicated operations such as JOIN and MERGE. A request from the general-purpose DB connector 1 to Riak 7 is made in the key-value format.

PostgresDBMS 5 is an RDBMS 4 that stores data in a table format. PostgresDBMS 5 supports complicated operations such as JOIN and MERGE. A request from the general-purpose DB connector 1 to PostgresDBMS 5 is made using SQL.

The JSON format data and the key-value format data may be converted into table format data. Here, table data is used as a general term for the JSON format data, the key-value format data, and the table format data.

In addition, although four DBMSs are illustrated in FIG. 3, the integrated DBMS 10 may have another number of DBMSs as long as it is two or more. Further, although two RDBMSs 4 are illustrated in FIG. 3, the integrated DBMS 10 may have one RDBMS 4 or three or more RDBMSs 4. Further, the integrated DBMS 10 may have another RDBMS 4 instead of PostgresDBMS 5. Further, the integrated DBMS 10 may have another DBMS that uses table data instead of MongoDBMS 6 or Riak 7.

The general-purpose DB connector 1 may accept a request from the user application 2 without going through the network 8. Further, the general-purpose DB connector 1 may communicate with the back-end DBMS group via the network.

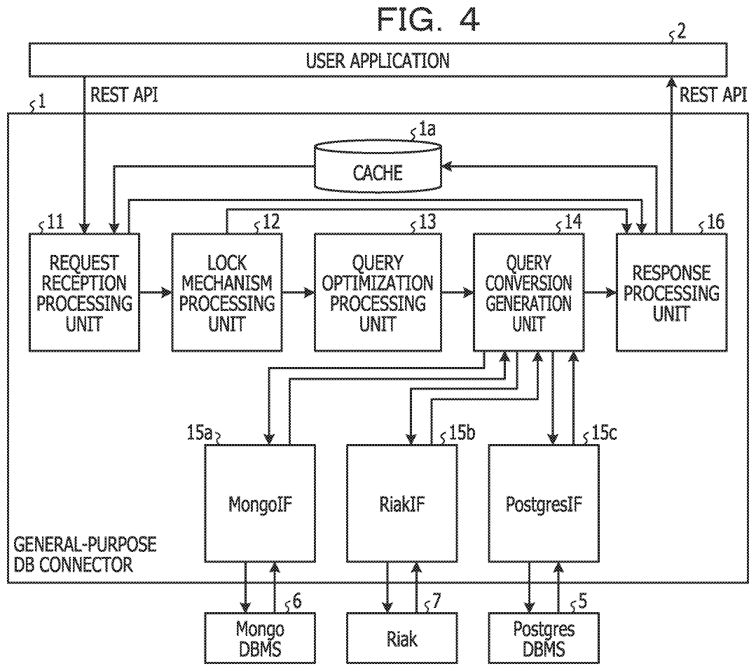

FIG. 4 is a diagram illustrating a functional configuration of the general-purpose DB connector 1. As illustrated in FIG. 4, the general-purpose DB connector 1 includes a request reception processing unit 11, a lock mechanism processing unit 12, a query optimization processing unit 13, a query conversion generation unit 14, a response processing unit 16, and a cache 1a. Further, the general-purpose DB connector 1 includes MongoIF 15a, RiakIF 15b, and PostgresIF 15c.

The request reception processing unit 11 receives a user request using the REST API from the user application 2, analyzes the user request, and determines whether the requested data is in the cache 1a. Then, when it is determined that the requested data is in the cache 1a, the request reception processing unit 11 requests that the response processing unit 16 respond to the user application 2 with the data in the cache 1a. Meanwhile, when it is determined that the requested data is not in the cache 1a, the request reception processing unit 11 passes the analysis result of the user request to the lock mechanism processing unit 12.

The lock mechanism processing unit 12 determines whether the user request is a lock request based on the analysis result of the user request, and when it is determined that it is a lock request, prohibits the update of the back-end DB group. Then, the lock mechanism processing unit 12 instructs the response processing unit 16 to respond to the success of lock. Further, when the user request is a release request, the lock mechanism processing unit 12 releases the update prohibition of the back-end DB group and instructs the response processing unit 16 to respond to the release success. Further, when a lock request is received from a data provider that provides the data related to the back-end DB group, the lock mechanism processing unit 12 instructs the response processing unit 16 to respond to a failure in response to the lock request from the user application 2.

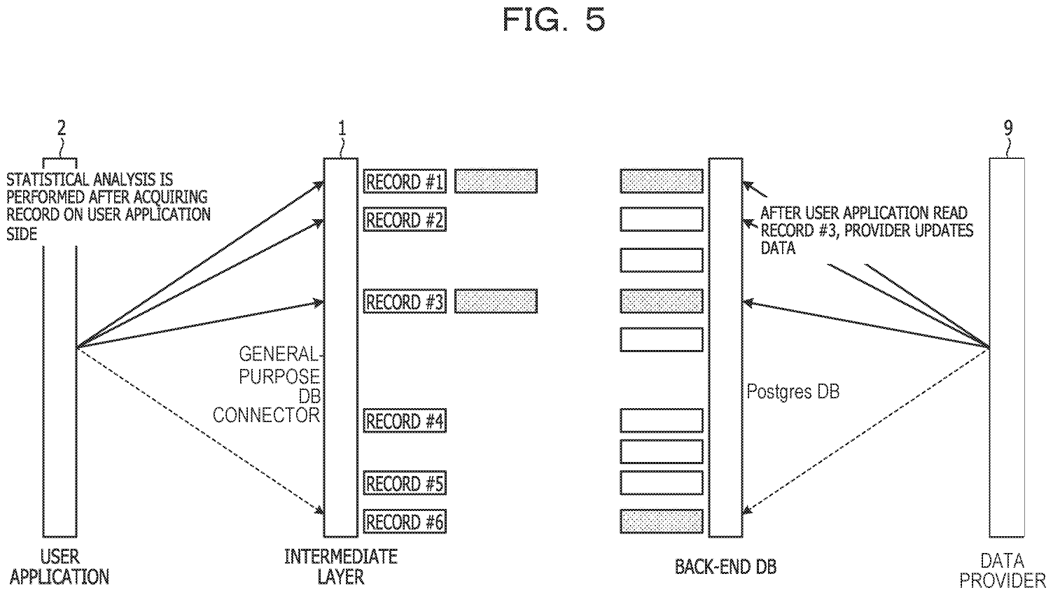

FIG. 5 is a diagram for explaining the reason for requesting the back-end DBMS group to lock the DB. In FIG. 5, the user application 2 performs a statistical analysis after acquiring records from the integrated DBMS 10. Further, the general-purpose DB connector 1 caches record #1 to record #6.

As illustrated in FIG. 5, after the user application 2 reads record #1 to record #3, the data provider 9 updates record #1, record #3, and record #6 of the PostgresDB. Then, when the user application 2 acquires up to record #6, the user application 2 acquires the data before the update for record #1 and record #3, and acquires the updated data for record #6.

In this way, when the back-end DB is updated while the user application 2 is acquiring the data, the user application 2 acquires the data in which the new data and the old data are mixed. Therefore, the user application 2 may not perform a correct statistical analysis. For this reason, the user application 2 requests the back-end DBMS group to lock the DB before acquiring or updating the data.

The query optimization processing unit 13 determines whether the user request is a complicated query based on the analysis result of the user request. Here, the complicated query is a query in which a complicated operation is performed over a plurality of pieces of table data, such as a JOIN query and a MERGE query. Then, when it is determined that the user request is a complicated query, the query optimization processing unit 13 specifies the destination DBMS to which the table data is integrated, based on the functions supported by the target DBMS and the size of the table data to be acquired.

In the embodiment, the destination DBMS is Postgres DBMS 5 which may process complicated queries. Further, in the embodiment, since there is a plurality of PostgresDBMSs 5, the destination DBMS is a DBMS that manages the largest table data among the table data which are the targets of the complicated queries.

Then, the query optimization processing unit 13 instructs the query conversion generation unit 14 to copy the table data stored in another DB to the DB managed by the specified DBMS. Then, the query optimization processing unit 13 instructs the query conversion generation unit 14 to process a complicated query to the specified DBMS.

When it is determined that the user request is not a complicated query, the query optimization processing unit 13 instructs the query conversion generation unit 14 to generate and execute a query corresponding to the user request.

The query conversion generation unit 14 generates a query to the DBMS related to the user request as an instruction processing unit based on the instruction of the query optimization processing unit 13, and issues a query to the DBMS that is the target of the generated query. For example, when the query conversion generation unit 14 is instructed to copy the table data from the query optimization processing unit 13, the query conversion generation unit 14 issues a query for acquiring the table data as intermediate table data to the copy source DBMS. Then, the query conversion generation unit 14 issues a query for inserting the acquired intermediate table data to the copy destination DBMS. Further, when the query conversion generation unit 14 is instructed by the query optimization processing unit 13 to process a complicated query, the query conversion generation unit 14 issues a complicated query to the DBMS designated by the query optimization processing unit 13.

Then, when receiving a response from the DBMS that issues the query, the query conversion generation unit 14 performs a process corresponding to the issued query. For example, when table data is acquired as a response from the copy source DBMS, a query for inserting the acquired table data is issued to the copy destination DBMS. Further, when the completion of inserting the table data is received as a response from the copy destination DBMS, the query conversion generation unit 14 issues a complicated query to the DBMS designated by the query optimization processing unit 13. When a response to the complicated query is received, the query conversion generation unit 14 passes the received response to the response processing unit 16.

When requested by the request reception processing unit 11, the response processing unit 16 responds to the user application 2 with the data in the cache 1a. Further, the response processing unit 16 transmits the response received from the query conversion generation unit 14 to the user application 2 as a response unit, and stores the response in the cache 1a. Further, the response processing unit 16 responds to the user application 2 with the success of lock and failure of lock based on the instruction of the lock mechanism processing unit 12.

MongoIF 15a is an interface with MongoDBMS 6. Based on the request from the query conversion generation unit 14, MongoIF1 5a instructs and makes an inquiry to MongoDBMS 6, and returns the response from MongoDBMS 6 to the request destination. RiakIF 15b is an interface with Riak 7. RiakIF 15b instructs and makes an inquiry to Riak 7 based on the request from the query conversion generation unit 14, and returns the response from Riak 7 to the request destination. PostgresIF 15c is an interface with PostgresDBMS 5. PostgresIF 15c instructs and makes an inquiry to PostgresDBMS 5 based on the request from the query conversion generation unit 14, and returns the response from PostgresDBMS 5 to the request destination.

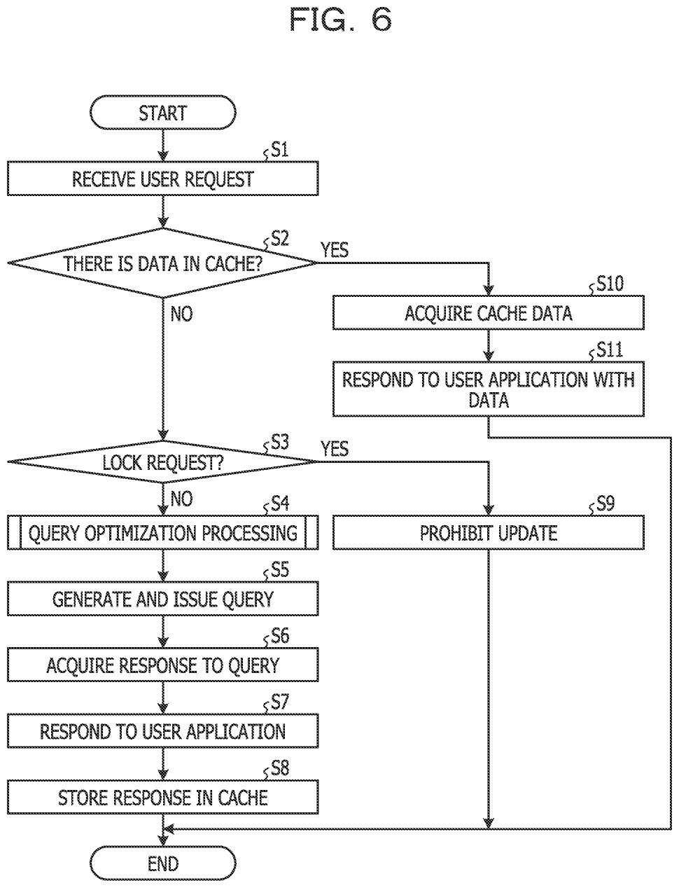

Next, the flow of processing by the general-purpose DB connector 1 will be described. FIG. 6 is a flowchart illustrating a flow of processing by the general-purpose DB connector 1. As illustrated in FIG. 6, the general-purpose DB connector 1 accepts a user request (step S1) and determines whether there is data in the cache 1a (step S2).

Then, when it is determined that there is no data in the cache 1a, the general-purpose DB connector 1 determines whether the user request is a lock request (step S3). When it is determined that the user request is not a lock request, the general-purpose DB connector 1 performs query optimization processing so that it may handle even when the user request is a complicated query (step S4). Then, the general-purpose DB connector 1 generates and issues a query based on the instruction created by the query optimization processing (step S5).

Then, the general-purpose DB connector 1 acquires a response to the query (step S6) and responds to the user application 2 (step S7). Further, when a plurality of queries is issued for a complicated query, the general-purpose DB connector 1 returns a response to the last issued query to the user application 2. Then, the general-purpose DB connector 1 stores the response to the user application 2 in the cache 1a (step S8).

Meanwhile, when it is determined in step S3 that the user request is a lock request, the general-purpose DB connector 1 prohibits the update of the back-end DB group (step S9). Further, when it is determined in step S2 that there is data in the cache 1a, the general-purpose DB connector 1 acquires the cache data (step S10) and responds to the user application 2 with the data (step S11).

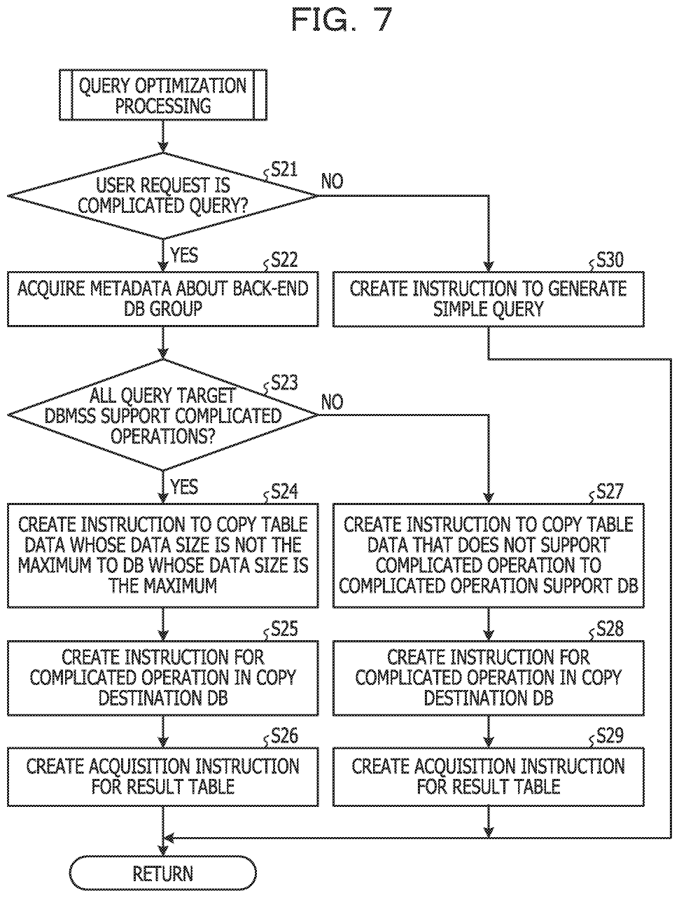

FIG. 7 is a diagram illustrating a flow of query optimization processing by the query optimization processing unit 13. As illustrated in FIG. 7, the query optimization processing unit 13 determines whether the user request is a complicated query (step S21). In the case where it is determined that the user request is a complicated query, the query optimization processing unit 13 acquires information about the back-end DB group (step S22). Specifically, the query optimization processing unit 13 acquires the function supported by the DBMS that is the target of the complicated query and the size of the table data that is the target of the complicated query.

Then, the query optimization processing unit 13 determines whether all the query target DBMSs support complicated operations (step S23). Then, when it is determined that all the query target DBMSs support complicated operations, the query optimization processing unit 13 creates an instruction to copy the table data whose data size is not the maximum to the DB whose data size is the maximum (step S24). Then, the query optimization processing unit 13 creates an instruction for a complicated operation in the copy destination DB (step S25). The complicated operation is, for example, a JOIN operation or a MERGE operation. Then, the query optimization processing unit 13 creates an acquisition instruction for the result table created as a result of the complicated operation (step S26).

Meanwhile, when it is determined that there is a DBMS that does not support the complicated operation in step S23, an instruction to copy the table data that does not support the complicated operation to the complicated operation support DB is created (step S27). Then, the query optimization processing unit 13 creates an instruction for a complicated operation in the copy destination DB (step S28). Then, the query optimization processing unit 13 creates an acquisition instruction for the result table created as a result of the complicated operation (step S29).

Further, when it is determined in step S21 that the user request is not a complicated query, the query optimization processing unit 13 creates an instruction to generate a simple query (step S30).

In this way, the query optimization processing unit 13 creates a plurality of instructions for executing a complicated query, so that the general-purpose DB connector 1 may execute a complicated query.

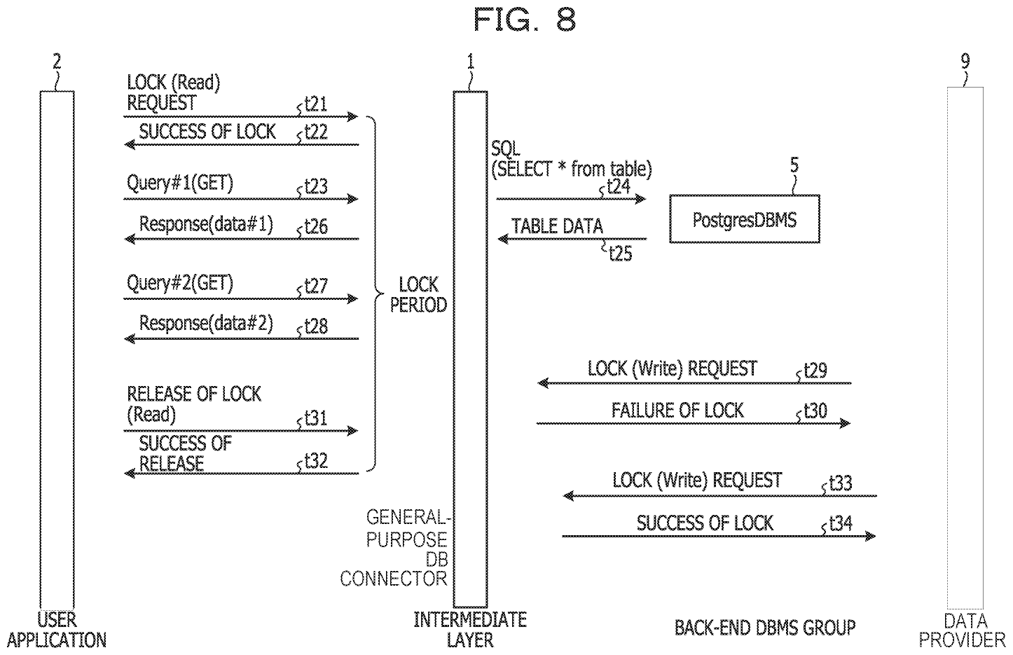

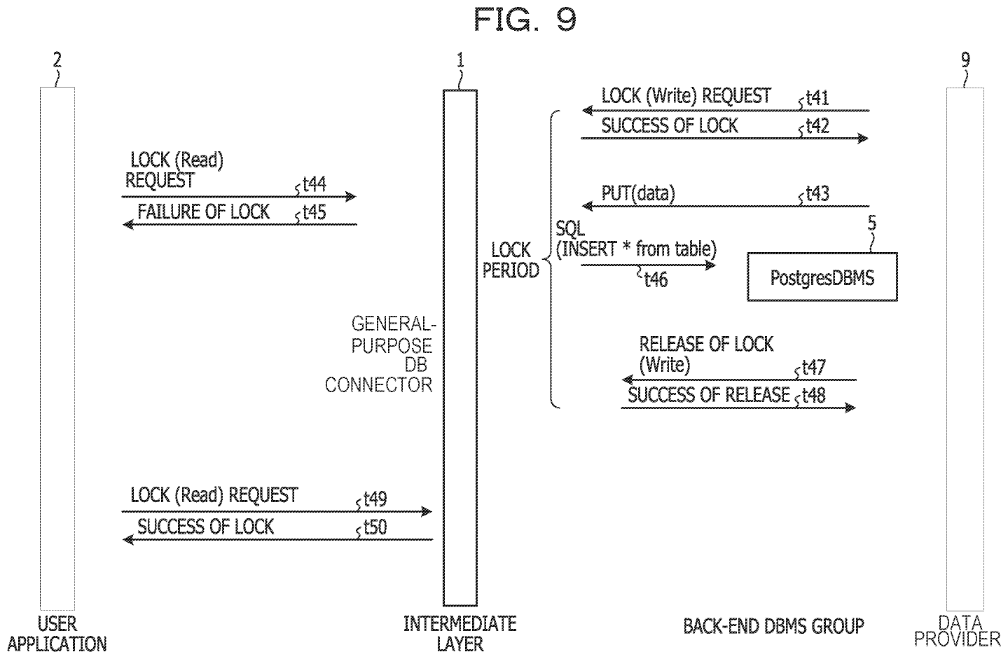

Next, the lock sequence will be described with reference to FIGS. 8 and 9. FIG. 8 illustrates a case where the DB cannot be updated while the cache 1a is being used, and FIG. 9 illustrates a case where the cache data cannot be used while the DB is being updated.

As illustrated in FIG. 8, the user application 2 transmits a lock (Read) request to the general-purpose DB connector 1 so that the DB cannot be updated while reading the cache 1a (t21). Then, the general-purpose DB connector 1 responds to the user application 2 with the success of the lock (t22).

Then, the user application 2 transmits a query related to data acquisition to the general-purpose DB connector 1 (t23). Here, it is assumed that the query is related to PostgresDB. Then, the general-purpose DB connector 1 issues a SELECT statement to PostgresDBMS 5 (t24) and acquires table data from PostgresDBMS 5 (t25). Then, the general-purpose DB connector 1 creates data #1 as a response from the acquired table data and transmits the created data #1 to the user application 2 (t26).

Then, the user application 2 transmits a query related to data acquisition to the general-purpose DB connector 1 (t27). Here, it is assumed that the query is related to the same table as the previous query. Then, the general-purpose DB connector 1 creates data #2 as a response from the table data acquired in the previous query and transmits the created data #2 to the user application 2 (t28).

Then, the data provider 9 transmits a lock (Write) request to the general-purpose DB connector 1 in order to update the DB (t29). Then, since the general-purpose DB connector 1 is in the lock period, the general-purpose DB connector 1 responds to the data provider 9 with a failure of lock (t30). Then, since the acquisition of the data is completed, the user application 2 transmits a lock (Read) release to the general-purpose DB connector 1 (t31). Then, the general-purpose DB connector 1 responds to the user application 2 with the success of release (t32).

Then, the data provider 9 transmits a lock (Write) request to the general-purpose DB connector 1 in order to update the DB (t33). Then, since the lock is released, the general-purpose DB connector 1 responds to the data provider 9 with the success of the lock (t34).

As described above, since the general-purpose DB connector 1 provides the lock mechanism so that the DB cannot be updated while the cache 1a is in use, the cache data and the data stored in the DB may be matched.

Further, as illustrated in FIG. 9, the data provider 9 transmits a lock (Write) request to the general-purpose DB connector 1 so that the cache data cannot be used during the DB update (t41). Then, the general-purpose DB connector 1 responds to the data provider 9 with the success of lock (t42). Then, the data provider 9 requests the general-purpose DB connector 1 to write data (t43). Here, it is assumed that the data write request is related to PostgresDB.

Meanwhile, the user application 2 transmits a lock (Read) request to the general-purpose DB connector 1 (t44). Then, the general-purpose DB connector 1 responds to the user application 2 with a failure of lock (t45).

The general-purpose DB connector 1 issues a SELECT statement to PostgresDBMS 5 in order to insert the data requested to be written by the data provider 9 into the DB (t46). Then, since the DB update is completed, the data provider 9 transmits the lock (Write) release to the general-purpose DB connector 1 (t47). Then, the general-purpose DB connector 1 responds to the data provider 9 with the success of release (t48). Then, the user application 2 transmits a lock (Read) request to the general-purpose DB connector 1 (t49). Then, the general-purpose DB connector 1 responds to the user application 2 with the success of lock (t50).

As described above, since the general-purpose DB connector 1 provides the lock mechanism so that the cache data cannot be used during the DB update, the cache data and the data stored in the DB may be matched.

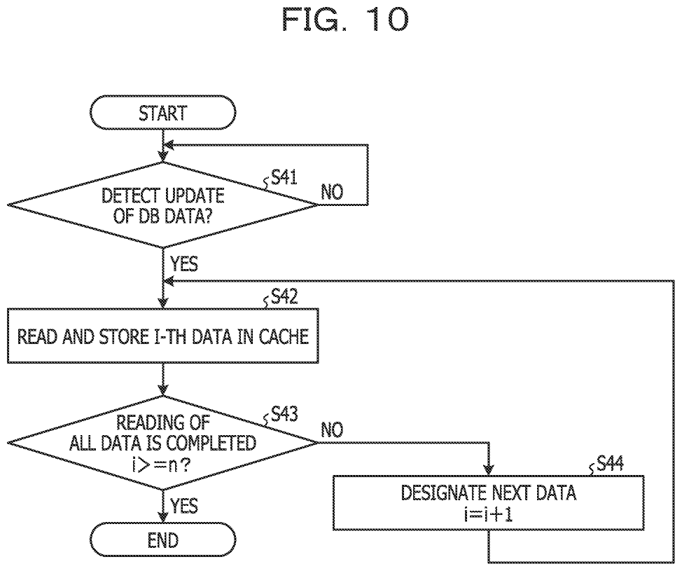

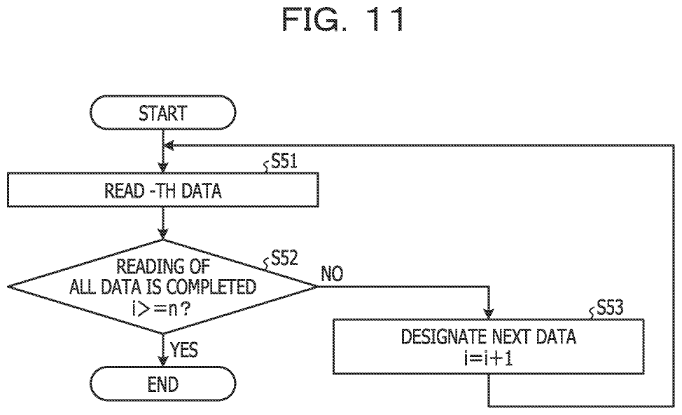

Next, the flow of processing for matching the data stored in the DB with the cache data when the DB is updated will be described with reference to FIGS. 10 and 11. FIG. 10 illustrates a process in which the general-purpose DB connector 1 updates the cache 1a, and FIG. 11 illustrates a process in which the user application 2 reads the data in the cache 1a after updating the cache 1a. Further, in FIGS. 10 and 11, it is assumed that there is n (positive integers) of updated data and the data are cached. Also, “i” is initialized with 1.

As illustrated in FIG. 10, the general-purpose DB connector 1 determines whether the DB data update has been detected (step S41), and when it is determined that the DB data update has been detected, reads the i-th data from the DB and stores the i-th data in the cache 1a (step S42).

Then, the general-purpose DB connector 1 determines whether the reading of all the updated data is completed (step S43). That is, the general-purpose DB connector 1 determines whether “i” is n or more. Then, when it is determined that there is data for which reading has not been completed, the general-purpose DB connector 1 designates the next data (step S44). That is, the general-purpose DB connector 1 adds 1 to “i.” Then, the general-purpose DB connector 1 returns to step S42.

Further, as illustrated in FIG. 11, the user application 2 reads the i-th data (step S51). Then, the user application 2 determines whether the reading of all the data has been completed (step S52). That is, the user application 2 determines whether “i” is n or more. Then, when it is determined that there is data for which reading has not been completed, the user application 2 specifies the next data (step S53). That is, the user application 2 adds 1 to “i.” Then, the user application 2 returns to step S51.

In this way, upon detecting the DB data update, the general-purpose DB connector 1 reads the cached data from the DB and stores it in the cache 1a, so that the data stored in the DB and the cached data may be matched.

As described above, in the embodiment, when the user request is a complicated query, the query optimization processing unit 13 specifies any PostgresDBMS 5 as a specific DBMS that processes the complicated query. Then, based on the instruction of the query optimization processing unit 13, the query conversion generation unit 14 issues a query to acquire the intermediate table data to the DBMS related to the complicated query other than the specific DBMS, and issues a query for inserting the acquired intermediate table data to the specific DBMS. Further, the query conversion generation unit 14 issues a complicated query to a specific DBMS based on the instruction of the query optimization processing unit 13. Then, the response processing unit 16 transmits a response to the complicated query to the user application 2. Therefore, the general-purpose DB connector 1 may eliminate the need for dedicated software or hardware for performing complicated operations, and may reduce the development cost.

Further, in the embodiment, the response processing unit 16 stores the response transmitted to the user application 2 in the cache 1a, so that the response to the same query may be performed at high speed.

Further, in the embodiment, the query optimization processing unit 13 specifies PostgresDBMS 5 having the largest size of the table data related to the complicated query from among the plurality of PostgresDBMSs 5 as a specific DBMS, so that the intermediate table data may be efficiently copied.

Further, in the embodiment, the lock mechanism processing unit 12 prohibits the update of the back-end DB group when the user request is a lock request, so that the cache 1a and the back-end DB group may be matched.

In the embodiment, the general-purpose DB connector 1 has been described, but by implementing the configuration of the general-purpose DB connector 1 by software, a database processing program having the same function may be obtained. A computer (information processing apparatus) that executes a database processing program will be described.

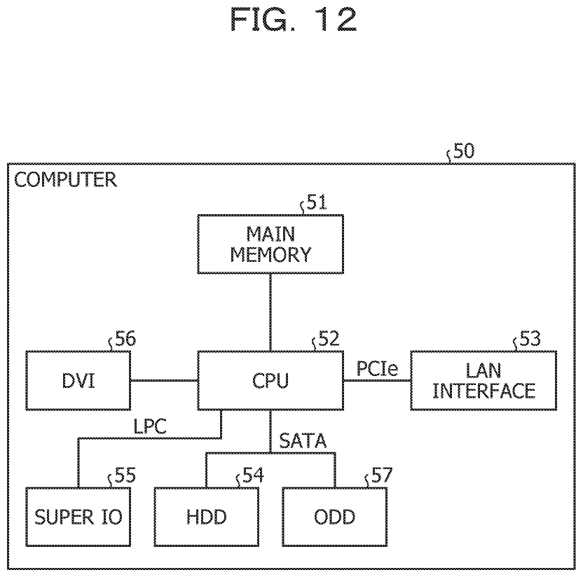

FIG. 12 is a diagram illustrating a hardware configuration of a computer that executes a database processing program according to the embodiment. As illustrated in FIG. 12, the computer 50 includes a main memory 51, a CPU (central processing unit) 52, a LAN (local area network) interface 53, and an HDD (hard disk drive) 54. Further, the computer 50 includes a super IO (input output) 55, a DVI (digital visual interface) 56, and an ODD (optical disk drive) 57.

The main memory 51 is a memory that stores a program, a result during execution of the program, and the like. The CPU 52 is a central processing unit that reads a program from the main memory 51 and executes the program. The CPU 52 includes a chipset having a memory controller.

The LAN interface 53 is an interface for connecting the computer 50 to another computer via a LAN. The HDD 54 is a disk device for storing programs and data, and the super IO 55 is an interface for connecting an input device such as a mouse or a keyboard. The DVI 56 is an interface for connecting a liquid crystal display device, and the ODD 57 is a device for reading and writing a DVD.

The LAN interface 53 is connected to the CPU 52 by PCI Express (PCIe), and the HDD 54 and the ODD 57 are connected to the CPU 52 by SATA (Serial Advanced Technology Attachment). The super IO 55 is connected to the CPU 52 by LPC (Low Pin Count).

Then, the database processing program executed by the computer 50 is stored in a DVD, which is an example of a recording medium readable by the computer 50, read from the DVD by the ODD 57, and installed in the computer 50. Alternatively, the database processing program is stored in a database or the like of another computer system connected via the LAN interface 53, read from these databases, and installed in the computer 50. Then, the installed data processing program is stored in the HDD 54, read into the main memory 51, and executed by the CPU 52.

According to an aspect of the embodiment, the development cost of a general-purpose DB connector may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiment of the present invention has been described in detail, it should be understood that the various changes, substitutions, and alterations could be made hereto without departing from the spirit and scope of the invention.

What is claimed is:

1. A method of processing database, the method comprising:
receiving, by a computer, an instruction from an application, the instruction being related to a plurality of database management systems including a database management system that performs an operation over a plurality of pieces of table data;
specifying a database management system among the plurality of database management systems;
acquiring intermediate table data used to execute the instruction from a database management system other than the specified database management system;
storing the acquired intermediate table data in a database managed by the specified database management system;
requesting execution of the instruction to the specified database management system;
acquiring response table data from the specified database management system; and
returning the acquired response table data to the application as a response to the instruction.

2. The method according to claim 1, the method further comprising:
caching the response table data in a memory of the computer.

3. The method according to claim 1, wherein
when there is only one database management system that performs the operation over the plurality of pieces of table data among the plurality of database management systems, the specifying specifies the only one database management system.

4. The method according to claim 1, wherein
when all of the plurality of database management systems perform the operation over the plurality of pieces of table data, the specifying specifies a database management system that has a largest size of table data used to execute the instruction.

5. The method according to claim 2, wherein
when a request for disabling an update of a database managed by each of the plurality of database management systems is received from the application before receiving the instruction, making a negative response to a request for an update of any database managed by the plurality of database management systems.

6. The method according to claim 1, wherein
the database management system that performs the operation over the plurality of pieces of table data is a relational database management system (RDBMS), and
the instruction is a JOIN instruction or a MERGE instruction.

7. A non-transitory computer-readable recording medium having stored therein a program that causes a computer to execute a process, the process comprising:
receiving an instruction from an application, the instruction being related to a plurality of database management systems including a database management system that performs an operation over a plurality of pieces of table data;
specifying a database management system among the plurality of database management systems;
acquiring intermediate table data used to execute the instruction from a database management system other than the specified database management system;
storing the acquired intermediate table data in a database managed by the specified database management system;
requesting execution of the instruction to the specified database management system;
acquiring response table data from the specified database management system; and
returning the acquired response table data to the application as a response to the instruction.

8. An information processing apparatus, comprising:
a memory; and
a processor coupled to the memory and the processor configured to:
receive an instruction from an application, the instruction being related to a plurality of database management systems including a database management system that performs an operation over a plurality of pieces of table data;
specify a database management system among the plurality of database management systems;
acquire intermediate table data used to execute the instruction from a database management system other than the specified database management system;
store the acquired intermediate table data in a database managed by the specified database management system;
requesting execution of the instruction to the specified database management system;
acquire response table data from the specified database management system; and
return the acquired response table data to the application as a response to the instruction.
